(19) United States
(12) Patent Application Publication
(10) Pub. No.: US 2018/0286598 A1
(43) Pub. Date: Oct. 4, 2018

(54) A METHOD OF MAKING A MULTILAYER STRUCTURE

(71) Applicants: Rohm and Haas Electronic Materials LLC, Marlborough, MA (US); DOW GLOBAL TECHNOLOGIES LLC, Midland, MI, MI (US)

(72) Inventors: Deyan Wang, Hudson, MA (US); Xiuyan Wang, Changning (CN); Shaoguang Feng, Shanghai (CN); Qiaowei Li, Shanghai (CN); Qingqing Pang, Shanghai (CN); Peter Trefonas, III, Medway, MA (US); Zhijian Lu, Boxborough, MA (US); Hongyu Chen, Zhangjian (CN)

(21) Appl. No.: 15/764,543

(22) PCT Filed: Sep. 29, 2015
(86) PCT No.: PCT/CN2015/091039

§ 371 Date: Mar. 29, 2018

(51) Int. Cl. H01G 11/36; H01G 11/46; H01G 11/34; H01G 11/86; B05D 1/00; B05D 3/02

(52) U.S. Cl. CPC H01G 11/36; H01G 11/46; B05D 3/0272; H01G 11/86; B05D 1/005; H01G 11/34

(57) ABSTRACT

A method of making a multilayer structure is provided, comprising providing a substrate; providing a coating composition, comprising: a liquid carrier and a MX/graphitic carbon precursor material having a formula (I); disposing the coating composition on the substrate to form a composite; optionally, baking the composite; annealing the composite under a forming gas atmosphere; whereby the composite is converted into an MX layer and a graphitic carbon layer disposed on the substrate providing the multilayer structure; wherein the MX layer is interposed between the substrate and the graphitic carbon layer in the multilayer structure.

### CROSS REFERENCE TO RELATED APPLICATIONS

This application claims priority to National Stage application PCT/CN2015/091039, filed Sep. 29, 2015, which is incorporated by reference in its entirety herein.

### BACKGROUND

The present invention relates to a method of making a multilayer structure using a coating composition comprising a solution borne MX/graphitic carbon precursor material. More particularly, the present invention relates to a method of making a multilayer electronic device structure on a substrate by applying to the substrate a coating composition comprising a solution borne MX/graphic carbon precursor material to form a composite, wherein the composite is subsequently converted into an MX layer (e.g., a metal oxide layer) and a graphitic carbon layer disposed on a surface of the substrate, wherein the MX layer is interposed between the substrate and the graphitic carbon layer.

Since successfully being separated from graphite in 2004 using tape, graphene has been observed to exhibit certain very promising properties. For example, graphene was observed by researchers at IBM to facilitate the construction of transistors having a maximum cut-off frequency of 155 GHz, far surpassing the 40 GHz maximum cut-off frequency associated with conventional silicon based transistors.

Graphene materials may exhibit a broad range of properties. A single layer graphene structure has a higher heat and electric conductivity than copper. A bilayer graphene exhibits a band gap that enables it to behave like a semiconductor. Graphene oxide materials have been demonstrated to exhibit a tunable band gap depending on the degree of oxidation. That is, a fully oxidized graphene would be an insulator, while a partially oxidized graphene would behave like a semiconductor or a conductor depending on its ratio of carbon to oxygen (C/O).

The electric capacitance of a capacitor using graphene oxide sheets has been observed to be several times higher than a pure graphene counterpart. This result has been attributed to the increased electron density exhibited by the functionalized graphene oxide sheets. Given the ultra thin nature of a graphene sheet, parallel sheet capacitors using graphene as the layers could provide extremely high capacitance-to-volume ratio devices—i.e., super capacitors. To date, however, the storage capacities exhibited by conventional super capacitors has severely limited their adoption in commercial applications where power density and high life cycles are required. Nevertheless, capacitors have many significant advantages over batteries, including shelf life. Accordingly, a capacitor with an increased energy density and without diminishing either power density or cycle life, would have many advantages over batteries for a variety of applications. Hence, it would be desirable to have high energy density/high power density capacitors with a long cycle life.

Liu et al. disclose self assembled multi-layer nanocomposites of graphene and metal oxide materials. Specifically, in U.S. Pat. No. 8,835,046, Liu et al. disclose an electrode comprising a nanocomposite material having at least two layers, each layer including a metal oxide layer chemically bonded directly to at least one graphene layer wherein the graphene layer has a thickness of about 0.5 nm to 50 nm, the metal oxide layers and graphene layers alternatingly positioned in the at least two layers forming a series of ordered layers in the nanocomposite material.

Notwithstanding, there remains a continuing need for methods of making multilayer structures comprising alternating layers of MX material (e.g., metal oxide) and graphitic carbon material for use in a variety of applications including as electrode structures in lithium ion batteries and in multilayer super capacitors.

The present invention provides a method of making a multilayer structure, comprising: providing a substrate; providing a coating composition, comprising: a liquid carrier and a MX/graphitic carbon precursor material having a formula (I)

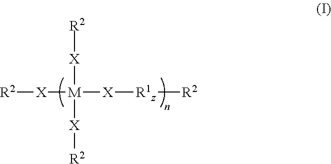

wherein M is selected from the group consisting of Ti, Hf and Zr; wherein each X is independently selected from the group consisting of N, S, Se and O; wherein R¹ group is selected from the group consisting of a —C₂₋₆ alkylene-X— group and a —C₂₋₆ alkylidene-X— group; wherein z is 0 to 5; wherein n is 1 to 15; wherein each R² group is independently selected from the group consisting of a hydrogen, a —C₁₋₂₀ alkyl group; a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the MX/graphitic carbon precursor material are —C(O)—C₁₀₋₆₀ polycyclic aromatic groups; disposing the coating composition on the substrate to form a composite; optionally, baking the composite; annealing the composite under a forming gas atmosphere; whereby the composite is converted into an MX layer and a graphitic carbon layer disposed on the substrate providing the multilayer structure; wherein the MX layer is interposed between the substrate and the graphitic carbon layer in the multilayer structure.

The present invention also provides an electronic device comprising a multilayered structure made according to the method of the present invention.

### BRIEF DESCRIPTION OF THE DRAWINGS

FIG. 1 is a depiction of a Raman spectrum for an annealed sample derived from a coating composition of the present invention.

FIG. 2 is a depiction of a Raman spectrum for an annealed sample derived from a coating composition of the present invention.

FIG. 3 is a depiction of a Raman spectrum for an annealed sample derived from a comparative coating composition.

FIG. 4 is a depiction of a Raman spectrum for an annealed sample derived from a coating composition of the present invention.

FIG. 5 is a transmission electron micrograph of a graphitic carbon film lifted from a multilayer structure deposited on the surface of a silicon wafer using a coating composition of the present invention.

FIG. 6 is a depiction of an XRD spectrum of a graphitic carbon film lifted from a multilayer structure deposited on the surface of a silicon wafer using a coating composition of the present invention.

FIG. 7 is a graph of showing the percent transmittance versus wavelength across the visible electromagnetic spectrum exhibited by a graphitic carbon film lifted from a multilayer structure deposited on the surface of a silicon wafer using a coating composition of the present invention.

### DETAILED DESCRIPTION

Energy storage devices with significantly improved performance will be a game changer in the utilization and implementation of renewable energy sources such as wind and solar and the associated beneficial reduction in greenhouse gas emissions. The method of making a multilayer structure of the present invention provides multilayer structures comprising alternating layers of MX and graphitic carbon. These multilayer structures may provide certain key components for energy storage devices with improved performance properties, wherein the multilayer structures provide high efficiency/high capacity energy storage in multilayered super capacitors and low resistance high capacity electrode structures in both super capacitors and next generation battery designs.

The method of making a multilayer structure of the present invention, comprises: providing a substrate; providing a coating composition, comprising: a liquid carrier and a MX/graphitic carbon precursor material having a formula (I)

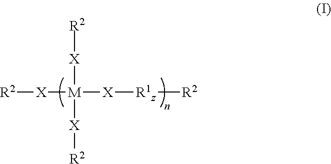

wherein M is selected from the group consisting of Ti, Hf and Zr (preferably, wherein M is selected from the group consisting of Hf, Zr; more preferably, wherein M is Zr); wherein each X is an atom independently selected from N, S, Se and O (preferably, wherein each X is independently selected from N, S and O; more preferably, wherein each X is independently selected from S and O; most preferably, wherein each X is an O); wherein n is 1 to 15 (preferably, 2 to 12; more preferably, 2 to 8; most preferably, 2 to 4); wherein R¹ is selected from the group consisting of a —C₂₋₆ alkylene-X— group and a —C₂₋₆ alkylidene-X— group (preferably, wherein R¹ is selected from the group consisting of a —C₂₋₄ alkylene-X— group and a —C₂₋₄ alkylidene-X— group; more preferably, wherein R¹ is selected from the group consisting of a —C₂₋₄ alkylene-O— group and a —C₂₋₄ alkylidene-O— group); wherein z is 0 to 5 (preferably, 0 to 4; more preferably, 0 to 2; most preferably, 0); wherein each R² group is independently selected from the group consisting of a hydrogen, a —C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % (preferably, 10 to 95 mol %; more preferably, 25 to 80 mol %; most preferably, 30 to 75 mol %) of the R² groups in the MX/graphitic carbon precursor material are —C(O)—C₁₀₋₆₀ polycyclic aromatic groups; disposing the coating composition on the substrate to form a composite; optionally, baking the composite; annealing the composite under a forming gas atmosphere; whereby the composite is converted into an MX layer and a graphitic carbon layer disposed on the substrate providing the multilayer structure; wherein the MX layer is interposed between the substrate and the graphitic carbon layer in the multilayer structure.

One of ordinary skill in the art will know to select appropriate substrates for use in the method of the present invention. Substrates used in the method of the present invention include any substrate having a surface that can be coated with a coating composition of the present invention. Preferred substrates include silicon containing substrates (e.g., silicon; polysilicon; glass; silicon dioxide; silicon nitride; silicon oxynitride; silicon containing semiconductor substrates, such as, silicon wafers, silicon wafer fragments, silicon on insulator substrates, silicon on sapphire substrates, epitaxial layers of silicon on a base semiconductor foundation, silicon-germanium substrates); certain plastics able to withstand the baking and annealing conditions; metals (e.g., copper, ruthenium, gold, platinum, aluminum, titanium and alloys thereof); titanium nitride; and non-silicon containing semiconductive substrates (e.g., non-silicon containing wafer fragments, non-silicon containing wafers, germanium, gallium arsenide and indium phosphide). Preferably, the substrate is a silicon containing substrate or a conductive substrate. Preferably, the substrate is in the form of a wafer or optical substrate such as those used in the manufacture of integrated circuits, capacitors, batteries, optical sensors, flat panel displays, integrated optical circuits, light-emitting diodes, touch screens and solar cells.

One of ordinary skill in the art will know to select an appropriate liquid carrier for the coating composition used in the method of the present invention. Preferably, liquid carrier in the coating composition used in the method of the present invention, is an organic solvent selected from the group consisting of aliphatic hydrocarbons (e.g., dodecane, tetradecane); aromatic hydrocarbons (e.g., benzene, toluene, xylene, trimethyl benzene, butyl benzoate, dodecylbenzene, mesitylene); polycyclic aromatic hydrocarbons (e.g., naphthalene, alkylnaphthalenes); ketones (e.g., methyl ethyl ketone, methyl isobutyl ketone, cyclohexanone); esters (e.g., 2-hydroxyisobutyric acid methyl ester, γ-butyrolactone, ethyl lactate); ethers (e.g., tetrahydrofuran, 1,4-dioxaneandtetrahydrofuran, 1,3-dioxalane); glycol ethers (e.g., diprolylene glycol dimethyl ether); alcohols (e.g., 2-methyl-1-butanol, 4-ethyl-2-pentol, 2-methoxy-ethanol, 2-butoxyethanol, methanol, ethanol, isopropanol, α-terpineol, benzyl alcohol, 2-hexyldecanol); glycols (e.g., ethylene glycol) and mixtures thereof. Preferred liquid carriers include toluene, xylene, mesitylene, alkylnaphthalenes, 2-methyl-1-butanol, 4-ethyl-2-pentol, γ-butyrolactone, ethyl lactate, 2-hydroxyisobutyric acid methyl ester, propylene glycol methyl ether acetate and propylene glycol methyl ether.

Preferably, the liquid carrier in the coating composition used in the method of the present invention, contains <10,000 ppm of water. More preferably, the liquid carrier in the coating composition used in the method of the present invention, contains <5000 ppm water. Most preferably, the liquid carrier in the coating composition used in the method of the present invention, contains <5500 ppm water.

The term “hydrogen” as used herein and in the appended claims includes isotopes of hydrogen such as deuterium and tritium.

Preferably, the MX/graphitic carbon precursor material used in the method of the present invention, has a chemical structure according to formula (I)

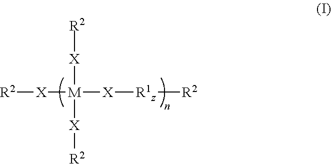

wherein M is selected from the group consisting of Ti, Hf and Zr; wherein each X is an atom independently selected from N, S, Se and O (preferably, wherein each X is independently selected from N, S and O; more preferably, wherein each X is independently selected from S and O; most preferably, wherein each X is O); wherein n is 1 to 15 (preferably, 2 to 12; more preferably, 2 to 8; most preferably, 2 to 4); wherein R¹ is selected from the group consisting of a —C₂₋₆ alkylene-X— group and a —C₂₋₆ alkylidene-X— group (preferably, wherein R¹ is selected from the group consisting of a —C₂₋₄ alkylene-X— group and a —C₂₋₄ alkylidene-X— group; more preferably, wherein R¹ is selected from the group consisting of a —C₂₋₄ alkylene-O— group and a —C₂₋₄ alkylidene-O— group); wherein z is 0 to 5 (preferably, 0 to 4; more preferably, 0 to 2; most preferably, 0); wherein each R² group is independently selected from the group consisting of a hydrogen, a C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the MX/graphitic carbon precursor material are —C(O)—C₁₀₋₆₀ polycyclic aromatic groups. More preferably, the MX/graphitic carbon precursor material used in the method of the present invention, has a chemical structure according to formula (I), wherein at least 10 mol % (preferably, 10 to 95 mol %; more preferably, 25 to 80 mol %; most preferably, 30 to 75 mol %) of the R² groups, are —C(O)—C₁₄₋₆₀ polycyclic aromatic groups. Most preferably, the MX/graphitic carbon precursor material used in the method of the present invention, has a chemical structure according to formula (I); wherein at least 10 mol % (preferably, 10 to 50 mol %; more preferably, 10 to 25 mol %) of the R² groups are —C(O)—C₁₆₋₆₀ polycyclic aromatic groups (more preferably, —C(O)—C₁₆₋₃₂ polycyclic aromatic groups; most preferably, 1-(8,10-dyhydropyren-4-yl)ethan-1-one groups).

Preferably, the MX/graphitic carbon precursor material used in the method of the present invention, is a metal oxide/graphitic carbon precursor material according to formula (I), wherein M is selected from the group consisting of Hf and Zr; wherein each X is O; wherein n is 1 to 15 (preferably, 2 to 12; more preferably, 2 to 8; most preferably, 2 to 4); wherein R¹ is selected from the group consisting of a —C₂₋₆ alkylene-O— group and a —C₂₋₆ alkylidene-O— group (preferably, wherein R¹ is selected from the group consisting of a —C₂₋₄ alkylene-O— group and a —C₂₋₄ alkylidene-O— group); wherein z is 0 to 5 (preferably, 0 to 4; more preferably, 0 to 2; most preferably, 0); wherein each R² group is independently selected from the group consisting of a hydrogen, a C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the MX/graphitic carbon precursor material are —C(O)—C₁₀₋₆₀ polycyclic aromatic groups. More preferably, the metal oxide/graphitic carbon precursor material used in the method of the present invention, has a chemical structure according to formula (I), wherein at least 10 mol % (preferably, 10 to 95 mol %; more preferably, 25 to 80 mol %; most preferably, 30 to 75 mol %) of the R² groups, are —C(O)—C₁₄₋₆₀ polycyclic aromatic groups. Most preferably, the metal oxide/graphitic carbon precursor material used in the method of the present invention, has a chemical structure according to formula (I); wherein at least 10 mol % (preferably, 10 to 50 mol %; more preferably, 10 to 25 mol %) of the R² groups are —C(O)—C₁₆₋₆₀ polycyclic aromatic groups (more preferably, —C(O)—C₁₆₋₃₂ polycyclic aromatic groups; more preferably, 1-(8,10-dyhydropyren-4-yl)ethan-1-one groups).

Preferably, the MX/graphitic carbon precursor material used in the method of the present invention, is a metal oxide/graphitic carbon precursor material according to formula (I), wherein M is selected from the group consisting of Hf and Zr; wherein each X is O; wherein n is 1 to 15 (preferably, 2 to 12; more preferably, 2 to 8; most preferably, 2 to 4); wherein z is 0; wherein each R² group is independently selected from the group consisting of a C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the MX/graphitic carbon precursor material are —C(O)—C₁₀₋₆₀ polycyclic aromatic groups. More preferably, the metal oxide/graphitic carbon precursor material used in the method of the present invention, has a chemical structure according to formula (I), wherein at least 10 mol % (preferably, 10 to 95 mol %; more preferably, 25 to 80 mol %; most preferably, 30 to 75 mol %) of the R² groups, are —C(O)—C₁₄₋₆₀ polycyclic aromatic groups. Most preferably, the metal oxide/graphitic carbon precursor material used in the method of the present invention, has a chemical structure according to formula (I); wherein at least 10 mol % (preferably, 10 to 50 mol %; more preferably, 10 to 25 mol %) of the R² groups are —C(O)—C₁₆₋₆₀ polycyclic aromatic groups (more preferably, —C(O)—C₁₆₋₃₂ polycyclic aromatic groups; more preferably, 1-(8,10-dyhydropyren-4-yl)ethan-1-one groups).

Preferably, the MX/graphitic carbon precursor material used in the method of the present invention, is a metal oxide/graphitic carbon precursor material according to the chemical structure of formula (I), wherein M is Zr; wherein each X is O; wherein n is 1 to 15 (preferably, 2 to 12; more preferably, 2 to 8; most preferably, 2 to 4); wherein z is 0; wherein each R² group is independently selected from the group consisting of a C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the metal oxide/graphitic carbon precursor material are —C(O)—C₁₀₋₆₀ polycyclic aromatic groups. More preferably, the metal oxide/graphitic carbon precursor material used in the method of the present invention, has a chemical structure according to formula (I), wherein at least 10 mol % (preferably, 10 to 95 mol %; more preferably, 25 to 80 mol %; most preferably, 30 to 75 mol %) of the R² groups, are —C(O)—C₁₄₋₆₀ polycyclic aromatic groups. Most preferably, the metal oxide/graphitic carbon precursor material used in the method of the present invention, has a chemical structure according to formula (I); wherein at least 10 mol % (preferably, 10 to 50 mol %; more preferably, 10 to 25 mol %) of the R² groups are —C(O)—C₁₆₋₆₀ polycyclic aromatic groups (more preferably, —C(O)—C₁₆₋₃₂ polycyclic aromatic groups; more preferably, 1-(8,10-dyhydropyren-4-yl)ethan-1-one groups).

Preferably, the MX/graphitic carbon precursor material used in the method of the present invention, is a metal oxide/graphitic carbon precursor material according to the chemical structure of formula (I), wherein M is Zr; wherein each X is O; wherein n is 1 to 15 (preferably, 2 to 12; more preferably, 2 to 8; most preferably, 2 to 4); wherein z is 0; wherein each R² group is independently selected from the group consisting of a C₁₋₂₀ alkyl group, a —C(O)—C₂₋₃₀ alkyl group, a —C(O)—C₆₋₁₀ alkylaryl group, a —C(O)—C₆₋₁₀ arylalkyl group, a —C(O)—C₆ aryl group and a —C(O)—C₁₀₋₆₀ polycyclic aromatic group; wherein at least 10 mol % of the R² groups in the metal oxide/graphitic carbon precursor material are —C(O)—C₁₀₋₆₀ polycyclic aromatic groups; wherein 30 mol % of the R² groups in the MX/graphitic carbon precursor material are butyl groups; 55 mol % of the R² groups in the MX/graphitic carbon precursor material are —C(O)—C₇ alkyl groups; and 15 mol % of the R² groups in the MX/graphitic carbon precursor material are —C(O)—C₁₇ polycyclic aromatic groups.

Preferably, the MX/graphitic carbon precursor material used in the method of the present invention, has a chemical structure according to formula (I), wherein at least 10 mol % of the R² groups in the MX/graphitic carbon precursor material are —C(O)—C₁₀₋₆₀ polycyclic aromatic groups. Preferably, the polycyclic aromatic groups contain at least two component rings that are joined in such a manner that each component ring shares at least two carbon atoms (i.e., wherein the at least two component rings that share at least two carbon atoms are said to be fused).

Preferably, the coating composition used in the method of the present invention contains 2 to 25 wt % of the MX/graphitic carbon precursor material. More preferably, the coating composition used in the method of the present invention contains 4 to 20 wt % of the MX/graphitic carbon precursor material. Most preferably, the coating composition used in the method of the present invention contains 4 to 16 wt % of the MX/graphitic carbon precursor material.

Preferably, the method of making a multilayer structure of the present invention, further comprises: providing a polycyclic aromatic additive; and, incorporating the polycyclic aromatic additive into the coating composition; wherein the polycyclic aromatic additive is selected from the group consisting of C₁₀₋₆₀ polycyclic aromatic compounds having at least one functional moiety attached thereto, wherein the at least one functional moiety is selected from the group consisting of a hydroxyl group (—OH), a carboxylic acid group (—C(O)OH), a —OR³ group and a —C(O)R³ group; wherein R³ is selected from the group consisting of a —C₁₋₂₀ linear or branched, substituted or unsubstituted alkyl group (preferably, wherein R³ is a —C₁₋₁₀ alkyl group; more preferably, wherein R³ is a —C₁₋₅ alkyl group; most preferably, wherein R³ is a —C₁₋₄ alkyl group). Preferably, the polycyclic aromatic additive is selected from the group consisting of C₁₄₋₄₀ polycyclic aromatic compounds having at least one functional moiety attached thereto, wherein the at least one functional moiety is selected from the group consisting of a hydroxyl group (—OH) and a carboxylate group (—C(O)OH). More preferably, the polycyclic aromatic additive is selected from the group consisting of C₁₆₋₃₂ polycyclic aromatic compounds having at least one functional moiety attached thereto, wherein the at least one functional moiety is selected from the group consisting of a hydroxyl group (—OH) and a carboxylate group (—C(O)OH). Preferably, the polycyclic aromatic additive is incorporated into the coating composition by adding the polycyclic aromatic additive to the liquid carrier before or after the MX/graphitic carbon precursor material is added to the liquid carrier or formed in the liquid carrier, in situ.

Preferably, the coating composition used in the method of the present invention contains 0 to 25 wt % of the polycyclic aromatic additive. More preferably, the coating composition used in the method of the present invention contains 0.1 to 20 wt % of the polycyclic aromatic additive. Still more preferably, the coating composition used in the method of the present invention contains 0.25 to 7.5 wt % of the polycyclic aromatic additive. Most preferably, the coating composition used in the method of the present invention contains 0.4 to 5 wt % of the polycyclic aromatic additive.

Preferably, the coating composition used in the method of the present invention, further comprises: an optional additional component. Optional additional components include, for example, curing catalysts, antioxidants, dyes, contrast agents, binder polymers, rheology modifies and surface leveling agents.

Preferably, the method of making a multilayer structure of the present invention, further comprises: filtering the coating composition. More preferably, the method of making a multilayer structure of the present invention, further comprises: filtering the coating composition (for example passing the coating composition through a Teflon membrane) before disposing the coating composition on the substrate to form the composite. Most preferably, the method of making a multilayer structure of the present invention, further comprises: microfiltering (more preferably, nanofiltering) the coating composition to remove contaminants before disposing the coating composition on the substrate to form the composite.

Preferably, the method of making a multilayer structure of the present invention, further comprises: purifying the coating composition by exposing the coating composition to an ion exchange resin. More preferably, the method of making a multilayer structure of the present invention, further comprises: purifying the coating composition by exposing the coating composition to an ion exchange resin to extract charged impurities (for example undesirably cations and anions) before disposing the coating composition on the substrate to form the composite.

Preferably, in the method of making a multilayer structure of the present invention, the coating composition is disposed on the substrate to form a composite using a liquid deposition process. Liquid deposition processes include, for example, spin-coating, slot-die coating, doctor blading, curtain coating, roller coating, dip coating, and the like. Spin-coating and slot-die coating processes are preferred.

Preferably, the method of making a multilayer structure of the present invention, further comprises: baking the composite. Preferably, the composite can be baked during or after disposing the coating composition on the substrate. More preferably, the composite is baked after disposing the coating composition on the substrate to form the composite. Preferably, the method of making a multilayer structure of the present invention, further comprises: baking the composite in an air under atmospheric pressure. Preferably, the composite is baked at a baking temperature of ≤125° C. More preferably, the composite is baked at a baking temperature of 60 to 125° C. Most preferably, the composite is baked at a baking temperature of 90 to 115° C. Preferably, the composite is baked for a period of 10 seconds to 10 minutes. More preferably, the composite is baked for a baking period of 30 seconds to 5 minutes. Most preferably, the composite is baked for a baking period of 6 to 180 seconds. Preferably, when the substrate is a semiconductor wafer, the baking can be performed by heating the semiconductor wafer on a hot plate or in an oven.

Preferably, in the method of making a multilayer structure of the present invention, the composite is annealed at an annealing temperature of ≥150° C. More preferably, the composite is annealed at an annealing temperature of 450° C. to 1,500° C. Most preferably, the composite is annealed at an annealing temperature of 700 to 1,000° C. Preferably, the composite is annealed at the annealing temperature for an annealing period of 10 seconds to 2 hours. More preferably, the composite is annealed at the annealing temperature for an annealing period of 1 to 60 minutes. Most preferably, the composite is annealed at the annealing temperature for an annealing period of 10 to 45 minutes.

Preferably, in the method of making a multilayer structure of the present invention, the composite is annealed under a forming gas atmosphere. Preferably, the forming gas atmosphere comprises hydrogen in an inert gas. Preferably, the forming gas atmosphere is hydrogen in at least one of nitrogen, argon and helium. More preferably, the forming gas atmosphere is 2 to 5.5 vol % hydrogen in at least one of nitrogen, argon and helium. Most preferably, the forming gas atmosphere is 5 vol % hydrogen in nitrogen.

Preferably, in the method of making a multilayer structure of the present invention, the multilayer structure provided is an MX layer and a graphitic carbon layer disposed on the substrate, wherein the MX layer is interposed between the substrate and the graphitic carbon layer in the multilayer structure. More preferably, the multilayer structure provided is a metal oxide layer and a graphitic carbon layer disposed on the substrate, wherein the metal oxide layer is interposed between the substrate and the graphitic carbon layer in the multilayer structure. Preferably, the graphitic carbon layer is a graphene oxide layer. Preferably, the graphitic carbon layer is a graphene oxide layer having a carbon to oxygen (C/O) molar ratio of 1 to 10.

Preferably, the method of making a multilayer structure of the present invention, further comprises disposing the coating composition on top of the previously provided multilayer structure, wherein a plurality of alternating MX layers (preferably, metal oxide layers) and graphitic carbon layers are disposed on the substrate. This results in a cured structure having an alternating structure of cured MX layers (preferably, metal oxide layers) and graphitic carbon layers. This process may be repeated any number of times to build a stack of such alternating layers.

The multilayer structures produced by the method of the present invention are useful in a variety of applications, including as components in electronic devices, in electric storage systems (e.g., as energy storage components of supercapacitors; as electrodes in lithium ion batteries) and as barrier layers for impeding water and/or oxygen permeation. A wide variety of electronic device substrates may be used in the present invention, such as: packaging substrates such as multichip modules; flat panel display substrates, including flexible display substrates; integrated circuit substrates; photovoltaic device substrates; substrates for light emitting diodes (LEDs, including organic light emitting diodes or OLEDs); semiconductor wafers; polycrystalline silicon substrates; and the like. Such substrates are typically composed of one or more of silicon, polysilicon, silicon oxide, silicon nitride, silicon oxynitride, silicon germanium, gallium arsenide, aluminum, sapphire, tungsten, titanium, titanium-tungsten, nickel, copper, and gold. Suitable substrates may be in the form of wafers such as those used in the manufacture of integrated circuits, optical sensors, flat panel displays, integrated optical circuits, and LEDs. As used herein, the term “semiconductor wafer” is intended to encompass “an electronic device substrate,” “a semiconductor substrate,” “a semiconductor device,” and various packages for various levels of interconnection, including a single-chip wafer, multiple-chip wafer, packages for various levels, or other assemblies requiring solder connections.

Some embodiments of the present invention will now be described in detail in the following Examples.

### Example 1: Preparation of Coating Composition

A coating composition comprising a metal oxide/graphitic carbon precursor material in a liquid carrier was prepared as follows. An organic polytitanate (Tyzor® BTP an n-butyl polytitanate, available from Dorf Ketal Specialty Catalysts, LLC) was reacted to replace 80 mol % of the butyl (Bu) moieties with —C(O)—C₇ alkyl moieties and —C(O)—C₁₀ polycyclic aromatic moieties in a 3:2 molar ratio as depicted in the reaction scheme

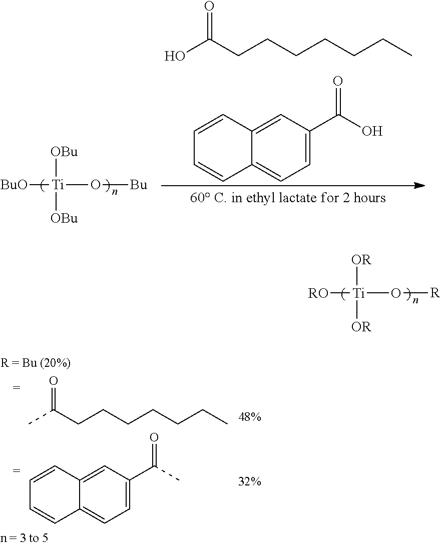

Specifically, the organic polytitanate (4.801 g, Tyzor® BTP an n-butyl polytitanate) was added to a first flask along with 10.0 g of ethyl lactate. Octanoic acid (3.769 g) and 2-naphthoic acid were added to a second flask along with 10.59 g of ethyl lactate. The contents of the second flask were then added drop wise to the contents of the first flask with continuous stirring over a period of twenty minutes. The combined contents of were then heated to 60° C. for 2 hours with continuous stirring. The heat source was then removed and the combined contents were allowed to cool to room temperature, providing a product coating composition. By weight loss method in a thermal oven, the product coating composition was determined to contain 19.27 wt % solids.

### Weight Loss Method

Approximately 0.1 g of the product coating composition was weighed into a tared aluminum pan. Approximately 0.5 g of the liquid carrier used to form the product coating composition (i.e., ethyl lactate) was added to the aluminum pan to dilute the test solution to make it cover the aluminum pan more evenly. The aluminum pan was then heated in a thermal oven at approximately 110° C. for 15 minutes. After the aluminum pan cooled to room temperature, the weight of the aluminum pan and the residual dried solid was determined, and the percentage solid content was calculated.

Based on the ligands added, the metal oxide/graphitic carbon precursor material contained in the product coating composition was according to the following formula

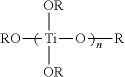

wherein n is 3 to 5; wherein 20 mol % of the R groups were —C₄ alkyl groups; wherein 48 mol % of the R groups were —C(O)—C₇ alkyl groups; and, wherein 32 mol % of the R groups were —C(O)—C₁₀ polycyclic aromatic groups.

### Example 2: Preparation of Coating Composition

A coating composition comprising a metal oxide/graphitic carbon precursor material in a liquid carrier was prepared as follows. Tetrabutoxyhafnium (5.289 g; available from Gelest, Inc.) and ethyl lactate (10.0 g) were added to a flask equipped with a reflux condenser, a mechanical stirrer and an addition funnel. With stirring, a solution of deionized water (0.1219 g) and ethyl lactate (5.1384 g) was then fed into the flask drop wise. The contents of the flask were then heated to reflux temperature and maintained at the reflux temperature for a period of 2 hours with continuous stirring. The contents of the flask were then allowed to cool to room temperature. A solution of octanoic acid (3.375 g) and 2-napthoic acid (2.682 g) in ethyl lactate (8.047 g) was then added to the flask drop wise with stirring. The contents of the flask were then heated to a temperature of 60° C. and maintained at that temperature for a period of 2 hours. The contents of the flask were then allowed to cool to room temperature. By weight loss method, the coating composition was determined to contain 17.5 wt % solids (determined by weight loss method as described above in Example 1). A portion of the coating composition (6.1033 g) was diluted with ethyl lactate (6.1067 g) to provide a product coating composition containing 8.75 wt % solids. Based on the ligands added, the metal oxide/graphitic carbon precursor material contained in the product coating composition was according to the following formula

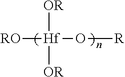

wherein n is 3 to 5; wherein 60 mol % of the R groups were —C(O)—C₇ alkyl groups; and, wherein 40 mol % of the R groups were —C(O)—C₁₀ polycyclic aromatic groups.

### Deposition of Multilayer Structures

The coating compositions prepared according to each of Examples 1 and 2 were filtered through a 0.2 μm PTFE syringe filter four times before spin coating on separate bare silicon wafers at 1,500 rpm and then backing at 100° C. for 60 seconds. The coated silicon oxide wafers were then cleaved into 1.5″×1.5″ wafer coupons. The coupons were then placed in an annealing vacuum oven. The wafer coupons were then annealed under a reduced pressure of a forming gas (5 vol % H₂ in N₂) for 20 minutes at 900° C. using the following temperature ramping profile:

Ramp up: from room temperature to 900° C. over 176 minutes
Soak: maintain at 900° C. for 20 minutes
Ramp down: from 900° C. to room temperature over slightly longer than 176 minutes.

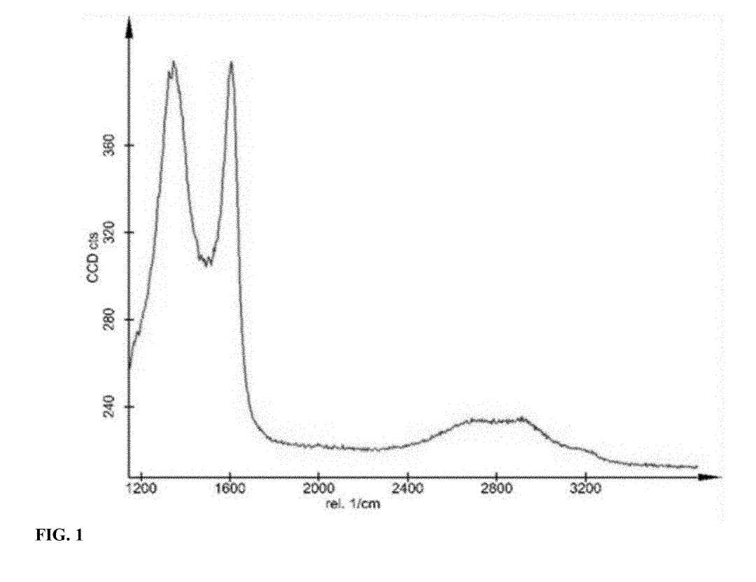

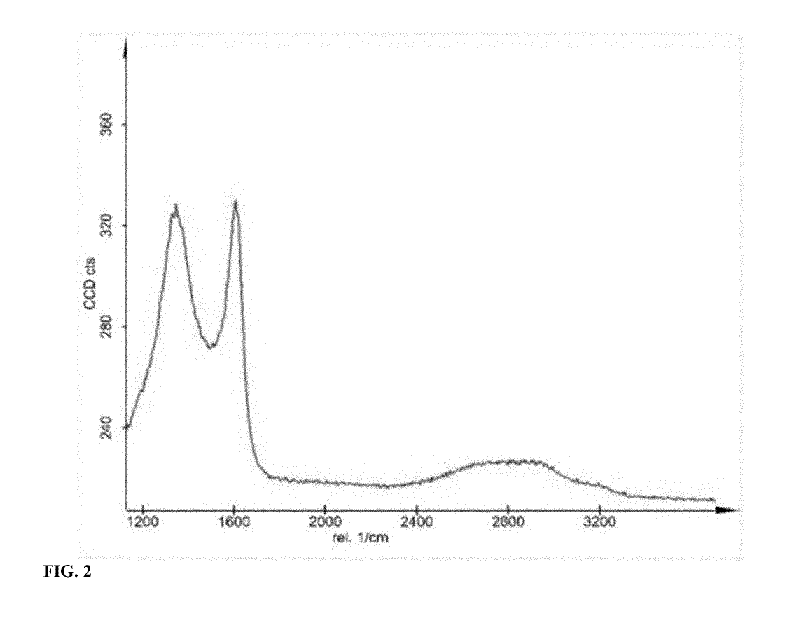

The coated surface of each of the wafer coupons post annealing had a shinning metallic appearance. The deposited materials were observed to comprise a multilayer structure with an in situ formed metal oxide film on the surface of the wafer coupons interposed between the surface of the wafer coupon and an overlying graphitic carbon layer. The graphitic carbon layers were then analyzed using a Witec confocal Raman microscope. The Raman spectra for the annealed samples derived from the coating compositions of Examples 1 and 2 are provided in FIGS. 1 and 2, respectively. These Raman spectra match well with literature graphene oxide spectra for single layer as well as 5-layer graphene oxide films.

### Comparative Example C1: Preparation of Coating Composition

A coating composition comprising a metal oxide/graphitic carbon precursor material in a liquid carrier was prepared as follows. Tetrabutoxyzirconium (230.2 mg; available from Gellest, Inc.) and ethyl lactate (2.48 mL) were added into a flask equipped with a mechanical stirrer and an addition funnel. The contents of the flask were then heated to 60° C. and maintained at that temperature. With stirring, a mixture of octanoic acid (43.3 mg) and benzoic acid (33.6 mg) was then added to the flask. The contents of the flask were then maintained at 60° C. with stirring for a period of 2 hours. While maintaining the flasks contents a 60° C., deionized water (7.2 μL) was then added to the flask with stirring. The contents of the flask were then maintained at 60° C. with stirring for a period of 2 hours. A solution of octanoic acid (183 mg) and benzoic acid (97 mg) in ethyl lactate (0.67 mL) was then added to the contents of the flask with vigorous stirring. The contents of the flask were then maintained at 60° C. with stirring for a period of 2 hours. The contents of the flask were then allowed to cool to room temperature. By weight loss method (as described above in Example 1), the coating composition was determined to contain 15 wt % solids. Based on the ligands added, the metal oxide/graphitic carbon precursor material contained in the product coating composition was according to the following formula

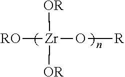

wherein n is ˜3; wherein 56 mol % of the R groups were —C(O)—C₇ alkyl groups; and, wherein 44 mol % of the R groups were —C(O)—C₆ aryl groups.

### Example 3: Preparation of Coating Composition

A coating composition comprising a metal oxide/graphitic carbon precursor material in a liquid carrier was prepared as follows. Tetrabutoxyzirconium (230 mg; available from Gellest, Inc.) and ethyl lactate (2.48 mL) were added into a flask equipped with a magnetic stirrer and an addition funnel. The contents of the flask were then heated to 60° C. and maintained at that temperature. With stirring, a mixture of octanoic acid (43.3 mg) and anthracene-9-carboxylic acid (66.7 mg) was then added to the flask. The contents of the flask were then maintained at 60° C. with stirring for a period of 2 hours. While maintaining the flasks contents a 60° C., deionized water (7.2 μL) was then added to the flask with stirring. The contents of the flask were then maintained at 60° C. with stirring for a period of 2 hours. A solution of octanoic acid (182.7 mg) and anthracene-9-carboxylic acid (192.8 mg) in ethyl lactate (0.67 mL) was then added to the contents of the flask with vigorous stirring. The contents of the flask were then maintained at 60° C. with stirring for a period of 2 hours. The contents of the flask were then allowed to cool to room temperature. By weight loss method (as described above in Example 1), the coating composition was determined to contain 15 wt % solids. Based on the ligands added, the metal oxide/graphitic carbon precursor material contained in the product coating composition was according to the following formula

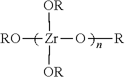

wherein n is ˜3; wherein 56 mol % of the R groups were —C(O)—C₇ alkyl groups; and, wherein 44 mol % of the R groups were —C(O)—C₁₄ polycyclic aromatic groups.

### Deposition of Multilayer Structures

The coating compositions prepared according to each of Comparative Example C1 and Example 3 were diluted to 5 wt % solids with ethyl lactate and then filtered through a 0.2 μm PTFE syringe filter four times before spin coating on separate bare silicon oxide wafer coupons of 1 cm×1 cm at 2,000 rpm and then backing at 100° C. for 60 seconds. The coupons were then placed in an annealing vacuum oven. The wafer coupons were then annealed under a reduced pressure of a forming gas (5 vol % H₂ in N₂) for 20 minutes at 900° C. using the following temperature ramping profile:

Ramp up: from room temperature to 900° C. over 176 minutes
Soak: maintain at 900° C. for 20 minutes
Ramp down: from 900° C. to room temperature over slightly longer than 176 minutes.

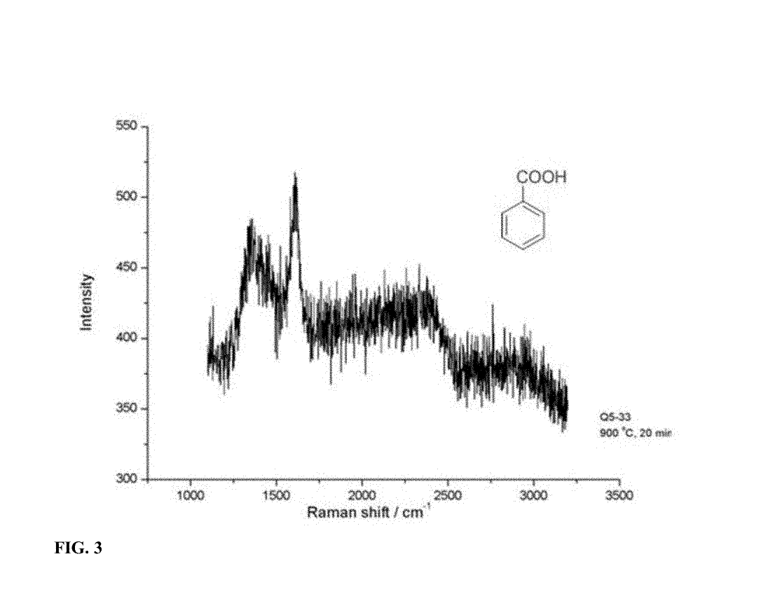

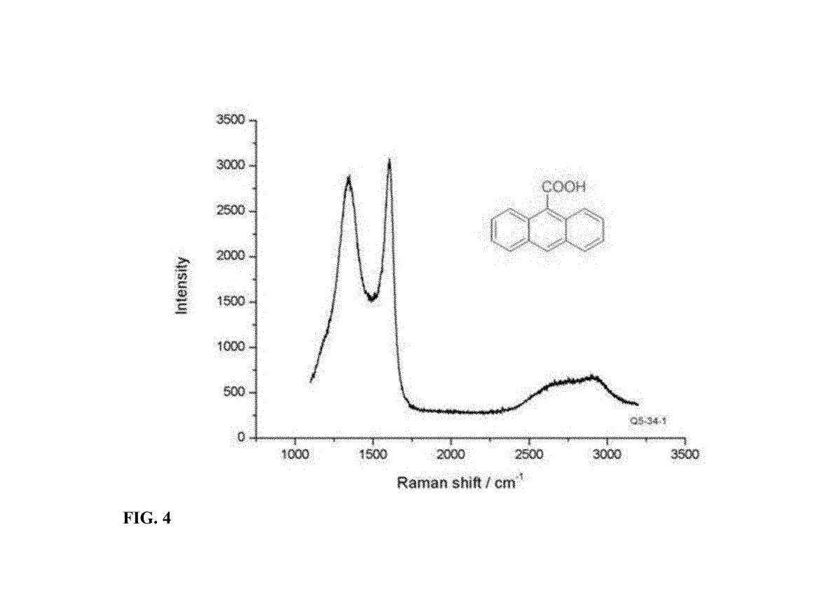

The deposited materials were observed to comprise a multilayer structure with an in situ formed metal oxide film on the surface of the wafer coupons interposed between the surface of the wafer coupon and an overlying carbon layer. The overlying carbon layers were analyzed using a Witec confocal Raman microscope. The Raman spectra for the annealed samples derived from the coating compositions of Comparative Example C1 and Example 3 are provided in FIGS. 3 and 4, respectively. The Raman spectrum for the overlying carbon layer derived from the coating composition of Example 3 matches well with literature graphene oxide spectra for single layer as well as 5-layer graphene oxide films. The Raman spectrum for the overlying carbon layer derived from the coating composition of Comparative Example C1 shows a nearly vanished graphene oxide characteristic.

### Resistivity and C/O Measurements

A coated wafer coupon derived using the coating composition according to Example 3 was evaluated using a 4-probe resistivity measurement tool to measure the electric conductivity of the deposited multilayer structure. The carbon to oxygen (C/O) molar ratio for the deposited graphitic carbon layer was also determined using a surface XPS analysis. The results of these measurements are provided in TABLE 1.

### Example 4: Preparation of Coating Composition

A coating composition comprising a metal oxide/graphitic carbon precursor material in a liquid carrier was prepared as follows. Tetrabutoxyzirconium (0.2880 g; available from Gellest, Inc.) and ethyl lactate (2.48 mL) were added into a flask equipped with a magnetic stirrer and an addition funnel. The contents of the flask were then heated to 60° C. and maintained at that temperature. With stirring, a mixture of octanoic acid (0.0260 g) and 2-napthoic acid (0.0310 g) was then added to the flask. The contents of the flask were then maintained at 60° C. with stirring for a period of 2 hours. While maintaining the flasks contents a 60° C., deionized water (7.2 μL) was then added to the flask with stirring. The contents of the flask were then maintained at 60° C. with stirring for a period of 1 hour. A solution of octanoic acid (0.0577 g) and 2-naphthoic acid (0.0344 g) in ethyl lactate (0.672 mL) was then added to the contents of the flask with vigorous stirring. The contents of the flask were then maintained at 60° C. with stirring for a period of 1 hour. The contents of the flask were then allowed to cool to room temperature. By weight loss method (as described above in Example 1), the coating composition was determined to contain 15 wt % solids. Based on the ligands added, the metal oxide/graphitic carbon precursor material contained in the product coating composition was according to the following formula

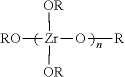

wherein n is ˜3; wherein 18 mol % of the R groups were —C₄ alkyl groups; wherein 47 mol % of the R groups were —C(O)—C₇ alkyl groups; and, wherein 35 mol % of the R groups were —C(O)—C₁₀ polycyclic aromatic groups.

### Deposition of Multilayer Structure

The coating compositions prepared according to Example 4 was diluted to 5 wt % solids with ethyl lactate and then filtered through a 0.2 μm TFPE syringe filter four times before spin coating on a bare silicon oxide wafer coupons of 1 cm×1 cm at 800 rpm for 9 seconds followed by 2,000 rpm for 30 seconds and then backing at 100° C. for 60 seconds. The coupons were then placed in an annealing vacuum oven. The wafer coupons were then annealed under a reduced pressure of a forming gas (5 vol % H₂ in N₂) for 20 minutes at 1,000° C. using the following temperature ramping profile:

Ramp up: from room temperature to 1,000° C. over 176 minutes
Soak: maintain at 1,000° C. for 20 minutes
Ramp down: from 1,000° C. to room temperature over slightly longer than 176 minutes.

### Resistivity and C/O Measurements

A coated wafer coupon derived using the coating composition according to Example 4 was evaluated using a 4-probe resistivity measurement tool to measure the electric conductivity of the deposited multilayer structure. The carbon to oxygen (C/O) ratio for the deposited graphitic carbon layer was also determined using a surface XPS analysis. The results of these measurements are provided in TABLE 1.

TABLE 1

| Multilayer structure derived | Resistivity | |
|---|---|---|
| from Coating Composition | (kΩ/sq) | C/O |
| Example 3 | 185 | 1.53 |
| Example 4 | 33 | 3.95 |

### Example 5: Preparation of Coating Composition

A coating composition comprising a metal oxide/graphitic carbon precursor material in a liquid carrier was prepared as follows. Tetrabutoxyzirconium (288 mg; available from Gellest, Inc.) and ethyl lactate (2.38 mL) were added into a flask equipped with a magnetic stirrer and an addition funnel. The contents of the flask were then heated to 60° C. and maintained at that temperature. With stirring, a mixture of octanoic acid (43.3 m g) and 1-pyrenecarboxylic acid (37.0 mg) was then added to the flask. The contents of the flask were then maintained at 60° C. with stirring for a period of 2 hours. While maintaining the flasks contents a 60° C., deionized water (7.2 μL) was then added to the flask with stirring. The contents of the flask were then maintained at 60° C. with stirring for a period of 2 hours. A solution of octanoic acid (83.6 mg) and 1-pyrenecarboxylic acid (22.1 mg) in ethyl lactate (0.68 mL) was then added to the contents of the flask with vigorous stirring. The contents of the flask were then maintained at 60° C. with stirring for a period of 2 hours. The contents of the flask were then allowed to cool to room temperature. By weight loss method (as described above in Example 1), the coating composition was determined to contain 15 wt % solids. Based on the ligands added, the metal oxide/graphitic carbon precursor material contained in the product coating composition was according to the following formula

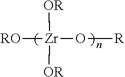

wherein n is ˜3; wherein 30 mol % of the R groups were —C₄ alkyl groups; wherein 55 mol % of the R groups were —C(O)—C₇ alkyl groups; and, wherein 15 mol % of the R groups were —C(O)—C₁₆ polycyclic aromatic groups.

### Deposition of Multilayer Structures

The coating composition prepared according to Example 5 was filtered through a 0.2 μm TFPE syringe filter four times. The coating composition was then divided into three separate spinning solutions, two of which were diluted with ethyl lactate to provide different solids concentrations (i.e., 5 wt %; 10 wt % and 15 wt %) before spin coating on separate bare silicon oxide wafer coupons of 1 cm×1 cm at 2,000 rpm and then backing at 100° C. for 60 seconds. The coupons were then placed in an annealing vacuum oven. The wafer coupons were then annealed under a reduced pressure of a forming gas (5 vol % H₂ in N₂) for 20 minutes at 1,000° C. using the following temperature ramping profile:

Ramp up: from room temperature to 1,000° C. over 176 minutes
Soak: maintain at 1,000° C. for 20 minutes
Ramp down: from 1,000° C. to room temperature over slightly longer than 176 minutes.

### Resistivity and Total Multiply Layer Structure Measurements

Coated wafer coupons derived using the different concentrations of the coating composition according to Example 5 were evaluated using a 4-probe resistivity measurement tool to measure the electric conductivity of the deposited multilayer structure. The thickness of the deposited multilayer film structures were also measured. The results of these measurements are provided in TABLE 2.

TABLE 2

| Multilayer structure derived | Resistivity | Total deposited film thickness |
|---|---|---|
| from Coating Composition | (kΩ/sq) | (nm) |
| Example 5 @ 15 wt % solids | 23 | 27 |
| Example 5 @ 10 wt % solids | 38 | 19 |
| Example 5 @ 5 wt % solids | 106 | 11 |

### Free Standing Graphitic Carbon Film

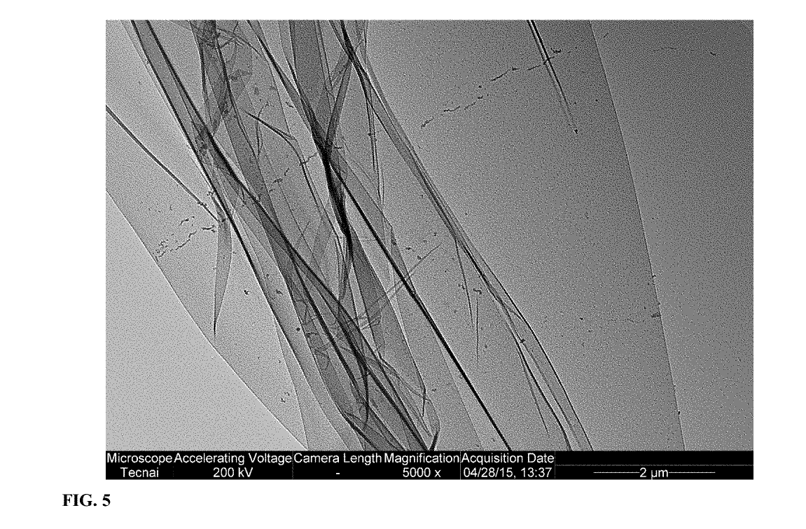

A coated wafer coupon prepared using a 5 wt % solids coating composition according to Example 5 was submersed in hydrofluoric acid. Upon submersion in the hydrofluoric acid, the graphitic carbon layer lifted from the multilayer deposited film structure and isolated. The free standing graphitic carbon film was transparent and flexible. A transmission electron micrograph of the lifted graphitic carbon film is provided in FIG. 5.

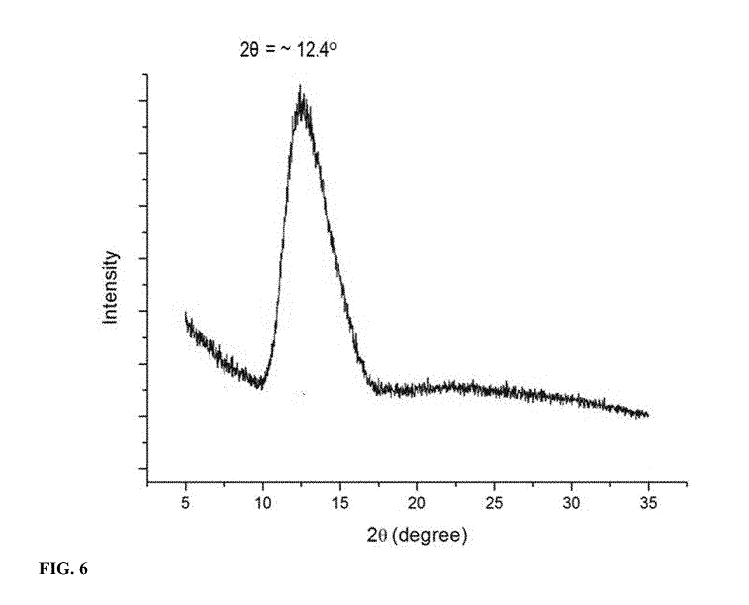

The lifted graphitic carbon film was analyzed by x-ray diffraction spectroscopy. The XRD spectrum is provided in FIG. 6 and shows a diffraction maximum at approximately 12.4° for the 2θ angle indicating an ordered layer structure of the graphitic carbon film. The 2θ angle of 12.4° corresponds to an interlayer spacing of 0.7 nm by Bragg's law.

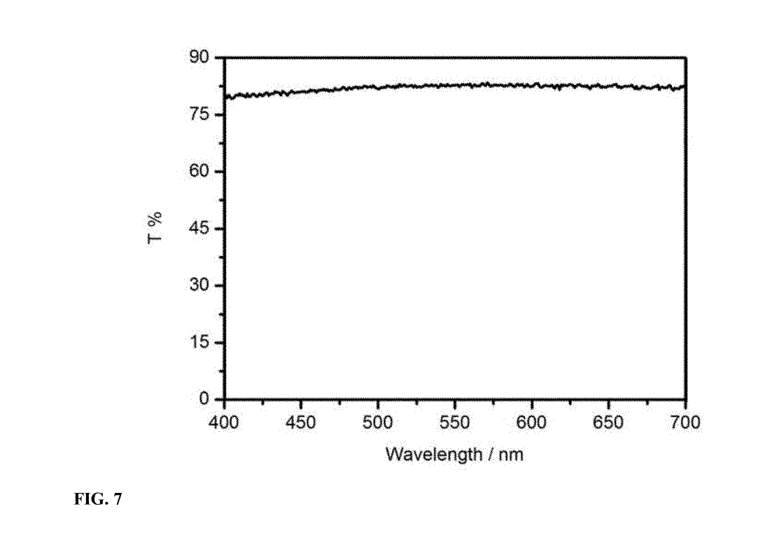

The percent transmittance of the lifted graphitic carbon film was measured across the visible spectrum and is depicted in graphical form in FIG. 7.

The sheet resistance of the lifted graphic carbon film was determined to be 20 kΩ/sq using a 4-probe resistivity measurement tool.

1. A method of making a multilayer structure, comprising:
providing a substrate;
providing a coating composition, comprising: a liquid carrier and a MX/graphitic carbon precursor material having a formula (I) 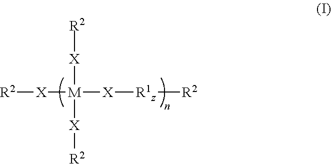
wherein M is selected from the group consisting of Ti, Hf and Zr; wherein each X is independently selected from the group consisting of N, S, Se and O; wherein R¹ group is selected from the group consisting of a —C₂₋₆ alkylene-X— group and a —C₂₋₆ alkylidene-X— group; wherein z is 0 to 5; wherein n is 1 to 15; wherein each R² group is independently selected from the group consisting of a hydrogen, a —C₁₋₂₀ alkyl group; a —C(O)—C₂₋₃₀ alkyl group; a —C(O)—C₆₋₁₀ alkylaryl group; a —C(O)—C₆₋₁₀ arylalkyl group; a —C(O)—C₆ aryl group; and, a —C(O)—C₁₀₋₆₀ polycyclic aromatic group; wherein at least 10 mol % of the R² groups in the MX/graphitic carbon precursor material are —C(O)—C₁₀₋₆₀ polycyclic aromatic groups;
disposing the coating composition on the substrate to form a composite;
optionally, baking the composite;
annealing the composite under a forming gas atmosphere;
whereby the composite is converted into an MX layer and a graphitic carbon layer disposed on the substrate providing the multilayer structure; wherein the MX layer is interposed between the substrate and the graphitic carbon layer in the multilayer structure.

2. The method of claim 1, wherein M is selected from the group consisting of Hf and Zr; wherein z is 0; wherein n is 1 to 5; and wherein each X is O.

3. The method of claim 2, wherein M is Zr.

4. The method of claim 2, wherein 30 to 75 mol % of the R² groups in the MX/graphitic carbon precursor material are —C(O)—C₁₀₋₆₀ polycyclic aromatic groups.

5. The method of claim 2, wherein at least 10 mol % of the R² groups in the MX/graphitic carbon precursor material are —C(O)—C₂₂₋₆₀ polycyclic aromatic groups.

6. The method of claim 2, further comprising:
providing a polycyclic aromatic additive; and, incorporating the polycyclic aromatic additive into the coating composition;
wherein the polycyclic aromatic additive is selected from the group consisting of C₁₀₋₆₀ polycyclic aromatic compounds having at least one functional moiety attached thereto, wherein the at least one functional moiety is selected from the group consisting of a hydroxyl group (—OH), a carboxylate group (—C(O)OH), a —OR³ group, and a —C(O)R³ group; wherein R³ is a —C₁₋₂₀ linear or branched, substituted or unsubstituted alkyl group.

7. The method of claim 3, wherein n is 2 to 4; and, wherein 30 to 75 mol % of the R² groups in the MX/graphitic carbon precursor material are —C(O)—C₁₀₋₆₀ polycyclic aromatic groups.

8. The method of claim 3, wherein 30 mol % of the R² groups in the MX/graphitic carbon precursor material are butyl groups; 55 mol % of the R² groups in the MX/graphitic carbon precursor material are —C(O)—C₇ alkyl groups; and 15 mol % of the R² groups in the MX/graphitic carbon precursor material are —C(O)—C₁₇ polycyclic aromatic groups.

9. The method of claim 3, further comprising:
providing a polycyclic aromatic additive; and, incorporating the polycyclic aromatic additive into the coating composition;
wherein the polycyclic aromatic additive is selected from the group consisting of C₁₀₋₆₀ polycyclic aromatic compounds having at least one functional moiety attached thereto, wherein the at least one functional moiety is selected from the group consisting of a hydroxyl group (—OH), a carboxylate group (—C(O)OH), a —OR³ group, and a —C(O)R³ group; wherein R³ is a —C₁₋₂₀ linear or branched, substituted or unsubstituted alkyl group.

10. An electronic device comprising a multilayer structure made according to the method of claim 1.
